(19) United States
(12) Patent Application Publication
(10) Pub. No.: US 2020/0141533 A1
(43) Pub. Date: May 7, 2020

(54) MASSAGE TABLE BELT DEVICE AND METHOD

(71) Applicant: Lisa Booth, Blanding, UT (US)

(72) Inventor: Lisa Booth, Blanding, UT (US)

(21) Appl. No.: 16/655,958

(22) Filed: Oct. 17, 2019

Related U.S. Application Data
(60) Provisional application No. 62/754,435, filed on Nov. 1, 2018.

(51) Int. Cl. F16M 13/02; A47G 11/00; A47B 97/00

(52) U.S. Cl. CPC F16M 13/02; A47B 97/00; A47G 11/003

(57) ABSTRACT

The massage table belt device includes a band of flexible material having a length, a width, a first end, a second end, an outer surface, an inner surface, a first side, and a second side, a fastener configured to detachably couple the first end and the second end together, and at least one flexible panel coupled to the band of flexible material; the flexible panel including, a top end, a bottom end, an exterior surface, an interior surface, and at least one pocket coupled to the exterior surface of the flexible panel. The massage table belt device is configured to provide a utility apron that is releasably couplable to a massage table.

### CROSS-REFERENCE TO RELATED APPLICATIONS

The present application is related to and claims priority to U.S. Provisional Patent Application No. 62/754,435 filed 1 Nov. 2018, which is incorporated by reference in its entirety.

### BACKGROUND OF THE INVENTION

The following includes information that may be useful in understanding the present disclosure. It is not an admission that any of the information provided is prior art nor material to the presently described or claimed inventions, nor that any publication or document that is specifically or implicitly referenced is prior art.

### TECHNICAL FIELD

The present invention relates generally to the field of physiotherapeutic tables of existing art and more specifically relates to a massage table belt device.

### RELATED ART

Many people in modern society like to get massages. Massage is the manipulation of soft tissues in the body. Massage techniques are commonly applied with hands, fingers, elbows, knees, forearms, feet, or a device. The purpose of massage is generally for the treatment of body stress or pain. A person who was professionally trained to give massages was traditionally known as a masseur (male) or a masseuse (female). In the United States, the title massage therapist has come to be used for those who have been professionally trained to give massages. In professional settings, clients are treated while lying on a massage table or other furniture. Coverings may be used to cover a furniture item for reasons of hygiene, comfort, and aesthetics. The current standard for a set of massage table sheets consist of three pieces; the top sheet (used to cover client), the bottom fitted sheet (used to cover the massage table), and the head cradle cover (used to cover the head cradle). Furthermore, treatment tables are often located away from any wall and furniture to permit the therapist or other practitioner to work around the entire perimeter of the treatment table, thereby requiring the therapist to place towels, tools, and oils on a nearby table or chair. Without a convenient and accessible location to place lotions, oils, and other items, massage therapists often feel disorganized. Some therapists will wear a belt around their waist to hold items, but these belts can be heavy and taxing on the lower back. The bulky belt can also impede their ability to work on their client. A suitable solution to provide efficiency is desired.

U.S. Pat. No. 3,791,382 to R Collins relates to a waterproof body covering with fluid receiving pockets. The described waterproof body coverings with fluid receiving pockets includes a surgical drape having a main sheet for placement on a patient's body for performing a surgical procedure. The drape has at least one pocket on the outer surface of the main sheet to receive fluid runoff from the site of surgical procedure.

### SUMMARY OF THE INVENTION

In view of the foregoing disadvantages inherent in the known physiotherapeutic table art, the present disclosure provides a novel massage table belt device. The general purpose of the present disclosure, which will be described subsequently in greater detail, is to provide an efficient and effective massage table belt device for use.

A massage table belt device is disclosed. The massage table belt device includes a band of flexible material having a length, a width, a first end, a second end, an outer surface, an inner surface, a first side, and a second side, a fastener configured to detachably couple the first end and the second end together, and at least one flexible panel coupled to the band of flexible material; the flexible panel including, a top end, a bottom end, an exterior surface, an interior surface, and at least one pocket coupled to the exterior surface of the flexible panel. The massage table belt device is configured to provide a utility apron that is releasably couplable to a massage table.

According to another embodiment, a method of use for a massage table belt device is also disclosed. The method of use for a massage table belt device includes the steps of providing the device comprising: a massage table belt including a band of flexible material having a length, a width, a first end, a second end, an outer surface, an inner surface, a first side, and a second side, a fastener configured to detachably couple the first end and the second end together, and at least one flexible panel coupled to the band of flexible material; the flexible panel including, a top end, a bottom end, an exterior surface, an interior surface, and at least one pocket coupled to the exterior surface of the flexible panel. The massage table belt device is configured to provide a utility apron that is releasably couplable to a massage table; next positioning the device on a massage table; then coupling the first end and the second end together; placing items inside the at least one pocket; removing items from the at least one pocket; detaching the device from the massage table; and then detaching the device from the massage table.

For purposes of summarizing the invention, certain aspects, advantages, and novel features of the invention have been described. Not necessarily all such advantages may be achieved in accordance with any one embodiment of the invention. Thus, the invention may be embodied or carried out in a manner that achieves or optimizes one advantage or group of advantages as taught without necessarily achieving other advantages as may be taught or suggested. The concluding portion of the specification particularly points out and distinctly claims the novel features of the invention. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a massage table belt device, constructed and operative according to the teachings of the present disclosure.

FIG. 1 is a perspective view of the massage table belt device during an ‘in-use’ condition, according to an embodiment of the disclosure.

FIG. 2 is a perspective view of the massage table belt device of FIG. 1, according to an embodiment of the present disclosure.

FIG. 3 is a perspective view of the massage table belt device of FIG. 1, according to an embodiment of the present disclosure.

FIG. 4 is a perspective view of the massage table belt device of FIG. 1, according to an embodiment of the present disclosure.

FIG. 5 is a flow diagram illustrating a method of use for a massage table belt device, according to an embodiment of the present disclosure.

The various embodiments of the present invention will be described in conjunction with the appended drawings, wherein like designations denote like elements.

### DETAILED DESCRIPTION

As discussed above, embodiments of the present disclosure relate to physiotherapeutic tables and more particularly to a massage table belt device as used to improve the use of such tables. Generally, since in most settings a massage table sits in the center of a room the present invention allows the therapist to have room to work around the table and to be able to massage the patient from all angles. Additionally, because massage therapy typically requires the use of oils, lotions, and small devices to help work the muscles smoothly; the lotions, oils and devices should be close by.

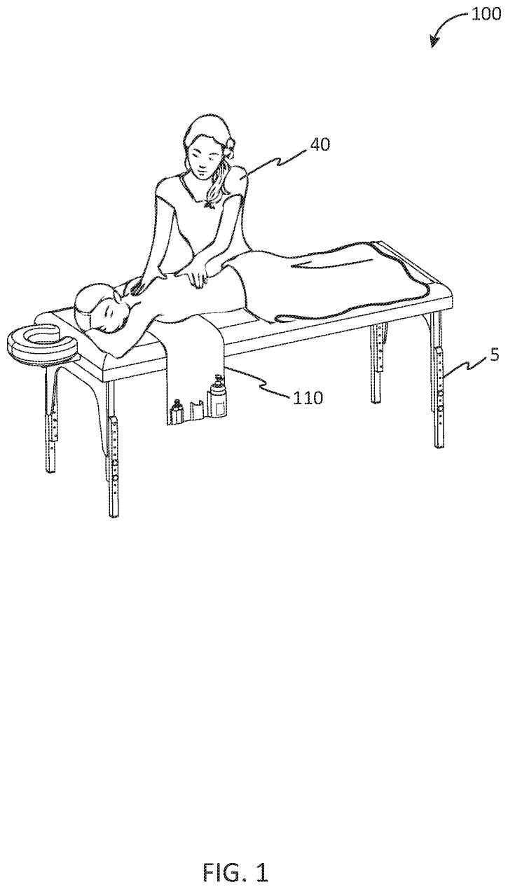

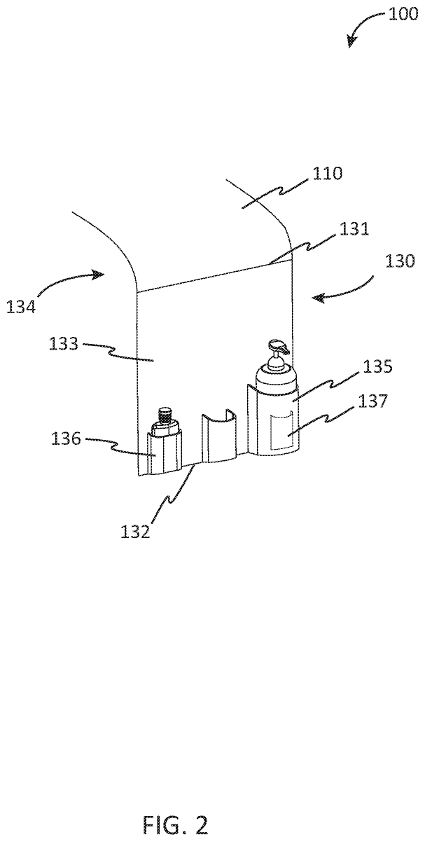

FIGS. 1-4 show various views of a massage table belt device (100). FIG. 1 shows a massage table belt device (100) during an ‘in-use’ condition, according to an embodiment of the present disclosure. Here, a user (40) may beneficially use the massage table belt device (100) to provide a portable pocket system on or across a massage table. The pocket system may be a length of cloth having integrated pockets. The cloth wraps around a massage table with the pockets hanging over the edges of the massage table, as shown in FIGS. 2-4. The portable pocket system may be useful for retaining massage oils and other items used in massage therapy. Further, the portable pocket system may store in a massage bag. As illustrated, the massage table belt device (100) may include a band (110) of flexible material having (defined by) a length (112), a width (113), a first end (114), a second end (115), an outer surface (116), an inner surface (117), a first side (118), and a second side (119); a fastener (120) configured to detachably couple the first (112) end and the second end (113) together; and one or more flexible panels (130) coupled to the band (110) of flexible material. The flexible panel (130) includes, a top end (131), a bottom end (132, an exterior surface (133), an interior surface (134), and at least one pocket (135) coupled to the exterior surface (133) of the flexible panel (130). The massage table belt device (100) is configured to provide a ‘utility apron’ that is releasably couplable to a massage table (5). The at least one pocket (135) couples to the exterior surface (133) of the flexible panel (130) includes an expandable feature and the at least one pocket (135) coupled to the exterior surface (133) of the flexible panel (130) which preferably comprises a plurality of pockets, as shown. The plurality of pockets may include a large pocket (135) and a small pocket (136).

Referring now to the band (110) of flexible material; the band (110) preferably comprises a cloth textile being flexible material for use in conforming to the massage table (5). The fastener (120) may be hook and loop or other fastening means, such as buttons, snaps, magnetic catches, etc. The fastener (120) provides for adjustment in the length (112) as desired. The flexible panel (130) attaches to the band (110) of flexible material perpendicular to the length (112); wherein the flexible panel (130) attaches to the band (110) of flexible material perpendicular to the length (112) at flexible panel (130) top end (131). The fastener (120) may comprise hook and loop attachment means; wherein the hook is preferably coupled to the first end (114) of the band (110) of flexible material on the outer surface (116) and the loop couples to the second end (115) of the band (110) of flexible material on the inner surface (117). According to one embodiment, the massage table belt device (100) may be arranged as a kit. In particular, the massage table belt device (100) may further include a set of instructions. The instructions may detail functional relationships in relation to the structure of the massage table belt device (100) such that the massage table belt device (100) can be used, maintained, or the like, in a preferred manner.

Referring now to FIGS. 2-4; FIG. 2 shows the massage table belt device (100) as removably coupled to the massage table (5) of FIG. 1, according to an embodiment of the present disclosure. The at least one flexible panel (130) couples to the band (110) of flexible material as above. The flexible panel (130) includes: a top end (131); a bottom end (132) an exterior surface (133); an interior surface (134); and at least one pocket (135) coupled to the exterior surface (133) of the flexible panel (130). As designed, the massage table belt device (100) is configured to provide a utility apron that is releasably couplable to a massage table (5), as shown in FIG. 1. The at least one pocket (135) couples to the exterior surface (133) of the flexible panel (130) and may include an expandable feature. The at least one pocket (135) couples to the exterior surface (133) of the flexible panel (130) comprises a plurality of pockets for use in holding items such as those shown (but not limited to). The plurality of pockets includes a large pocket (135) and a small pocket (136). The plurality of pockets may include a large pocket including a mini pocket (137) coupled thereon. The flexible material is a cloth textile. But other embodiments can employ other suitably equivalent materials.

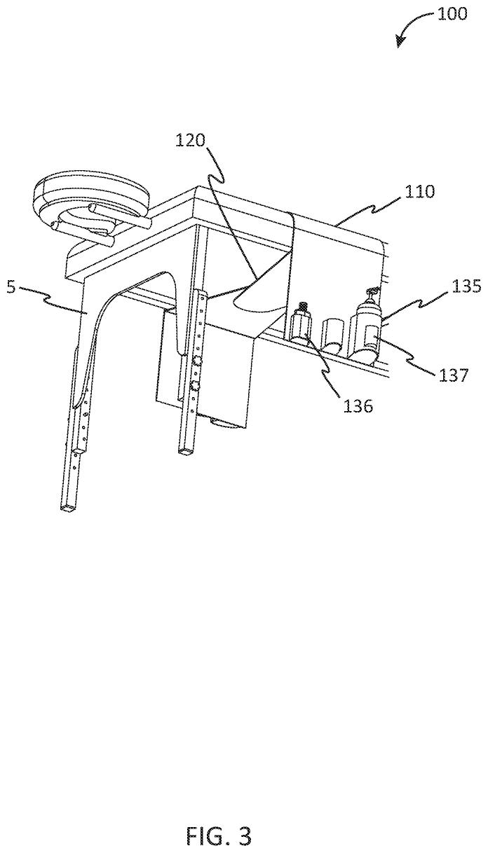

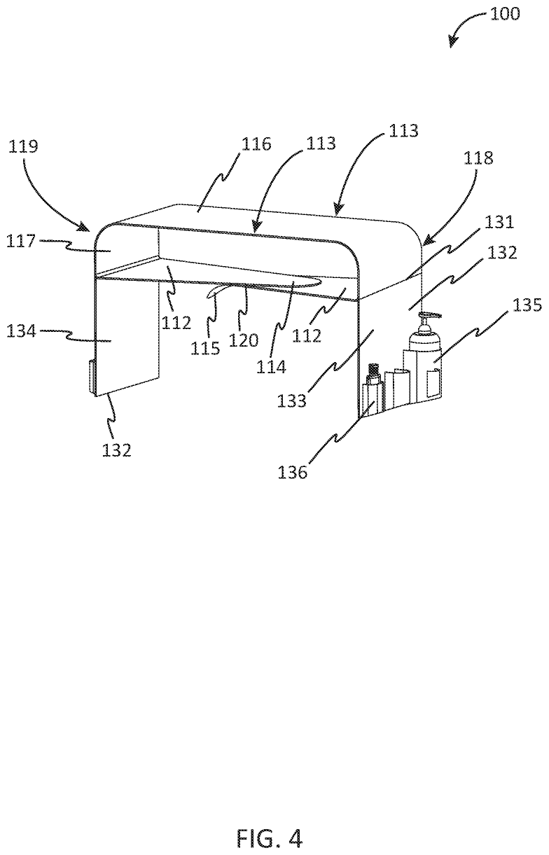

FIG. 3 is a bottom perspective view of the massage table belt device (100) of FIG. 1, according to an embodiment of the present disclosure showing the fastener (120) configured to detachably couple the first (112) end and the second end (113) together. FIG. 4 is a perspective view of the massage table belt of the massage table belt device (100) of FIG. 1, according to an embodiment of the present disclosure. The fastener (120), as previously mentioned, preferably comprises hook and loop for ease of coupling and uncoupling. In alternate embodiments the fastener (120) may be a tongue and buckle. The flexible material of the band (110) of the massage table belt device (100) is preferably elastomeric. The fastener (120) as designed can provide for adjustment in the length (112). Relationally speaking, the flexible panel (130) is preferably fixed to the band (110) of flexible material perpendicular to the length (112); wherein the flexible panel (130) is preferably fixed (or removably couplable in alternate embodiments) to the band (110) of flexible material perpendicular to the length (112) at the flexible panel (130) top end (131). The bottom end (132) can hang freely such that items can be positioned vertically for ease of use. The tongue couples to the first end (114) of the band (110) of flexible material. The buckle, when used, couples to the second end (115) of the band (110) of flexible material.

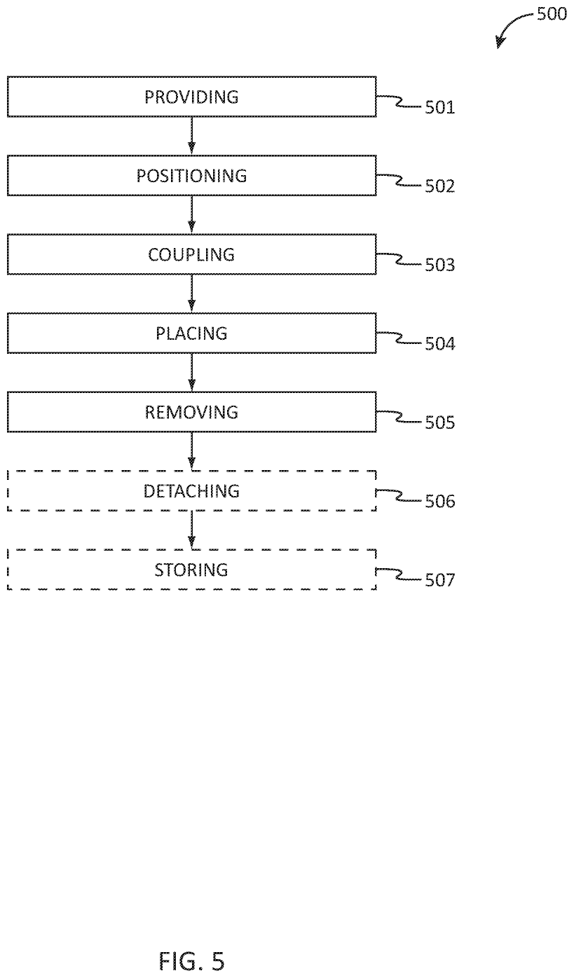

FIG. 5 is a flow diagram illustrating a method for massage table belt device (500), according to an embodiment of the present disclosure. In particular, the method for using the massage table belt device (500) may include one or more components or features of the massage table belt device (100) as described above. As illustrated, the method of use (500) may include the steps of: step one 501, providing, the massage table belt device (100) comprising: a massage table belt including a band (110) of flexible material having a length (112), a width (113), a first end (114), a second end (115), an outer surface (116), an inner surface (117), a first side (118), and a second side (119), a fastener (120) configured to detachably couple the first (112) end and the second end (113) together, and at least one flexible panel (130) coupled to the band (110) of flexible material; the flexible panel (130) including, a top end (131), a bottom end (132, an exterior surface (133), an interior surface (134), and at least one pocket (135) coupled to the exterior surface (131) of the flexible panel (130); step two 502, positioning the massage table belt device (100) on a massage table (5); step three 503, coupling the first end (112) and the second end (113) together; step four 504, placing items inside the at least one pocket (135); step five 505, removing items from the at least one pocket (135); step six 506, detaching the device from the massage table (5); and step seven 507, storing the device.

It should be noted that steps 506 and 507 may be optional steps and may not be implemented in all cases. Optional steps of method of use 500 are illustrated using dotted lines in FIG. 5 to distinguish them from the other steps of method of use 500. The steps described in the method of use can be carried out in many different orders according to user preference. The use of “step of” should not be interpreted as “step for”, in the claims and is not intended to invoke the provisions of 35 U.S.C. § 112(f). Under appropriate circumstances, considering such issues as design preference, user preferences, marketing preferences, cost, structural requirements, available materials, technological advances, etc., other methods for use of the massage table belt device are taught.

The embodiments of the invention described are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A massage table belt device, the device comprising:
a massage table belt including
a flexible band having
a length;
a first end;
a second end;
an outer surface;
and
an inner surface;
a fastener configured to detachably couple the first end and the second end; and
a flexible panel coupled to the band including a pocket coupled to the flexible pane and a top end;
wherein the band of flexible material is configured to releasably couple around a massage table.

2. The device of claim 1, wherein the pocket includes an expandable feature.

3. The device of claim 2, comprising a plurality of pockets.

4. The device of claim 3, wherein the pockets include a large pocket and a small pocket.

5. The device of claim 1, wherein the band of flexible material comprises cloth.

6. The device of claim 1, wherein the fastener is hook and loop.

7. The device of claim 1, wherein the fastener is a tongue and buckle.

8. The device of claim 1, wherein the band is elastomeric.

9. The device of claim 4, wherein the pockets include a mini pocket coupled to a large pocket.

10. The device of claim 1, wherein the fastener provides length adjustment.

11. The device of claim 1, wherein the flexible panel attaches to the band perpendicular to the length.

12. The device of claim 1, wherein the flexible panel attaches to the band perpendicular to the length at the top end.

13. The device of claim 1, wherein the flexible panel is removably coupled to the band perpendicular to the length at the top end.

14. The device of claim 7, wherein the tongue couples to the first end.

15. The device of claim 1, wherein the buckle couples to the second end.

16. The device of claim 6, wherein the fastener is hook and loop and the hook couples to the first end on the outer surface and the loop couples to the second end on the inner surface.

17. A massage table belt device:
a massage table belt including
an elastic cloth band having
an adjustable length,
a first end,
a second end,
an outer surface,
an inner surface,
a first side,
a second side,
hook-and-loop fastener with the hook coupled to the first end on the outer surface and the loop coupled to the second end on the inner surface and
a flexible panel perpendicularly coupled at a top end to the band and including a plurality of expandable pockets coupled to an exterior surface,
wherein the device releasably couples to a massage table;
and the plurality of pockets includes a large pocket and a small pocket;

18. The massage table belt device of claim 17, further comprising a set of instructions and wherein the massage table belt device is arranged as a kit.

19. A method of use for a massage table belt device, the method comprising the steps of:
providing the massage table belt device of claim 1;
positioning the device on a massage table;
coupling the first end and the second end together;
placing an item inside of a pocket;
and
removing the item from the pocket for use.

20. The method of claim 19, further comprising the steps of:
detaching the massage table belt device from the massage table;
and
storing the massage table belt device.
